(19) United States
(12) Patent Application Publication
(10) Pub. No.: US 2004/0032252 A1
(43) Pub. Date: Feb. 19, 2004

(54) Displacement sensing measuring device and apparatus

(75) Inventor: Bijan K. Amini, (US)

Correspondence Address: LAW OFFICE OF DAVID MCEWING, P.O. BOX 231324, HOUSTON, TX, 77023, US

(73) Assignee: EM-Tech Sensors LLC

(21) Appl. No.: 10/641,207

(22) Filed: Aug. 14, 2003

Related U.S. Application Data
(60) Provisional application No. 60/403,462, filed on Aug. 14, 2002.

(51) Int. Cl. G01B 7/14

(52) U.S. Cl. 324/207.17; 324/207.26; 324/207.14; 324/263

(57) ABSTRACT

An apparatus and method for measuring changes in pressure, temperature, speed, acceleration, vibration, or volume by detecting variations in one or more electrical circuits as the distance among a plurality of electrically conductive and magnetically permeable components changes. The invention utilizes changes in properties of electrical circuits induced by the variations in the intensity of a magnetic flux field resulting from spatial movements or displacement of the components. The components that make up the sensor may be electrically insulated from the electrical circuit that is the source of the magnetic flux field and detects the change and analyzes it as a measured change in pressure, temperature, speed, acceleration, vibration, volume, etc.

### CROSS REFERENCE TO RELATED APPLICATION

This application claims the benefit of and priority to U.S. Provisional Application No. 60/403,462 entitled “Displacement Sensing Measuring Device and Apparatus” and filed Aug. 14, 2003

### BACKGROUND OF INVENTION

1. Field of Use

The present invention has many applications for measuring differing properties such as volume, pressure, temperature, velocity, acceleration, or impulse by detecting variations in one or more electromagnetic circuits maintained remote and insulated from the object of interest. The invention allows use of electrical instrumentation and recording devices in applications that have previously been inaccessible or hazardous due to factors including, but not limited to, corrosion, flame or spark hazards.

2. Prior Art

Various displacement measuring devices have been long known and reliably used in many applications. Typically, the displacement measuring devices involve some mechanically moveable component in conjunction with an active electrical circuit, e.g., floats to measure volume, etc. Previous to this invention, however, it has not been possible to accurately or reliably measure or monitor changes in certain objects by such traditional mechanical devices, where there exist harsh or extreme environments in which the mechanical device, particularly flexible or moveable components, are to operate over prolonged periods or where the components are inaccessible for routine inspection and maintenance. It also has not been possible to utilize common electrical sensors, where an electrical current creates an unacceptable risk of spark, fire or explosion due to volatile compounds or other hazardous environmental conditions. Common electrical sensors or mechanical devices have also been unsuitable or impracticable for metal containment vessels that may not be breached.

### SUMMARY OF INVENTION

The method and apparatus taught by the invention subject of this specification utilizes the ability to transmit a magnetic signal through electrically conductive and magnetically permeable materials or across distances that have previously not been achievable. The invention also utilizes the ability to transmit magnetic signals through materials that previously have been considered barriers to the transmission of magnetic energy. The applicant has previously disclosed (i) methods of transmitting electromagnetic signals through electrically conductive and magnetically permeable materials, i.e., EM barriers and detecting changes in electrical resistivity of media existing on the opposite side of the EM barrier; (ii) apparatus and methods for engaging EM barrier materials with magnetic energy, transmitting magnetic energy through a portion and then along the opposite surface of the material such that the material behaves similar to an electromagnetic antenna; (iii) methods and apparatus for saturating or partially saturating EM barrier material such that the magnetic permeability is sufficiently reduced to enhance electromagnetic energy engaging with and penetrating through EM barrier material. Reference is made to published U.S. patents or patent applications of the Applicant, Ser. Nos. 09/781,667, 09/981,775 and U.S. Pat. No. 6,392,421, which are hereby incorporated by reference.

In the present specification, the applicant teaches use of some or all of these techniques to remotely create an insulated electric signal that can be detected by electrically insulated devices through one or more electrically conductive materials by the induction of magnetic energy.

Therefore, it is a goal of the present invention to provide an apparatus and method for measuring or detecting changes in properties, including but not limited to volume, pressure, temperature, velocity, acceleration or impulse, by the interaction of electrically conductive objects controlled by at least one of these properties with a magnetic field and a resulting induced electric signal. The measurement can be made through various barriers or container walls, e.g., through the wall of a steel tank, without breach or perforation of the tank wall.

It is a further goal to create a remote magnetic current or field that can be used to interact with moveable electrically conductive objects and generate an electric signal.

It is a further goal of this invention to utilize changes in a magnetic field to induce changes in various properties of electrical circuits, e.g., changes in impedance, voltage, current amplitude and phase.

It is yet another goal of this invention to utilize the detected change in magnetic energy to determine the quantity of the media or force of the phenomena responsible for the change in magnetic energy, e.g., change in temperature, vibration, acceleration, volume Or pressure.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 schematically illustrates the components of one embodiment of the apparatus subject of the invention.

FIG. 2 illustrates the embodiment of the invention used in the demonstration of the invention.

FIG. 2A illustrates an induced magnetic circuit.

FIGS. 2B and 2C illustrate the induced and bucking eddy currents within the magnetic circuit.

FIG. 3 illustrates the electrically conductive plate structures of the apparatus depicted in FIGS. 2, 2A, 2B and 2C.

FIG. 3A illustrates another embodiment of the plate structure.

FIG. 4 illustrates the measured induced voltage change resulting from a change in water volume used in the demonstration of the invention.

FIG. 5 illustrates another embodiment of the invention

FIG. 6 illustrates a component of the invention

FIG. 7 illustrates another embodiment of the invention.

FIG. 8 illustrates an alternate embodiment of the invention.

FIG. 9 depicts the results of the demonstration of the embodiment illustrated in FIG. 7 wherein increased pressure was placed upon a moveable disk adjacent to a steel pipe.

The above general description and the following detailed description are merely illustrative of the subject invention, and additional modes, advantages and particulars of this invention will be readily suggested to those skilled in the art without departing from the spirit and scope of the invention.

### DETAILED DESCRIPTION OF INVENTION

It is well known that an oscillating (or changing) magnetic flux will induce an electrical current (“eddy current”) within an electrically conductive object located within the field of the changing flux. It is also well known that the movement of an electrically conductive material through a magnetic field, e.g., the constant magnetic field of a permanent magnet, will induce an electric current within the conductive material. The magnitude of induced current (eddy current) will, of course, be related in part, to the rate of change of magnetic flux, the conductivity or rate of movement of the material, and the intensity of the magnetic field. A change of either the induced electric current or magnetic flux causes an interaction with the other, and the result of the interaction can be detected. The detected signals are used to provide information concerning the material or the media existing on the opposite side of the material, e.g., measuring the volume (or change in volume) of the contents within a steel tank.

One embodiment of the present invention utilizes measured changes in impedance of an electric circuit resulting from a change or movement in a magnetic flux or an electrically conductive material to determine, for example, the volume of liquid in a tank. This example would rely upon the changes in volume causing a discernible change in the separation among separate and electrically insulated components. The change in distance would be detected by the change in impedance, voltage or current of one or more electric circuits.

It will be appreciated that the relationship between distance of the materials and the volume or other properties can be controlled by known and conventional methods. A change in volume of a liquid may cause the distance between two components (for example, two electrically conductive plates located in a magnetic field or magnetic circuit) to move in relation to the other. For example, if the quantity of a liquid in a fixed wall container increases, the level of the liquid rises within the container. The increased height increases the weight of the liquid above the device, there by causing a space between the two plates to contract by various and well known methods. As the space between the first and second materials changes in response to the change in weight or pressure, a change in the magnetic field or electric current can be detected. For example, the compression of a gap between two electrically conductive plates or disks within a steel tank may cause a detectable change in an electric current used to induce a magnetic field in one of the conductive disks. The detected change may be changed impedance, current or voltage. Useful information can be extrapolated from the change in one of these factors when the other variables are known or constant.

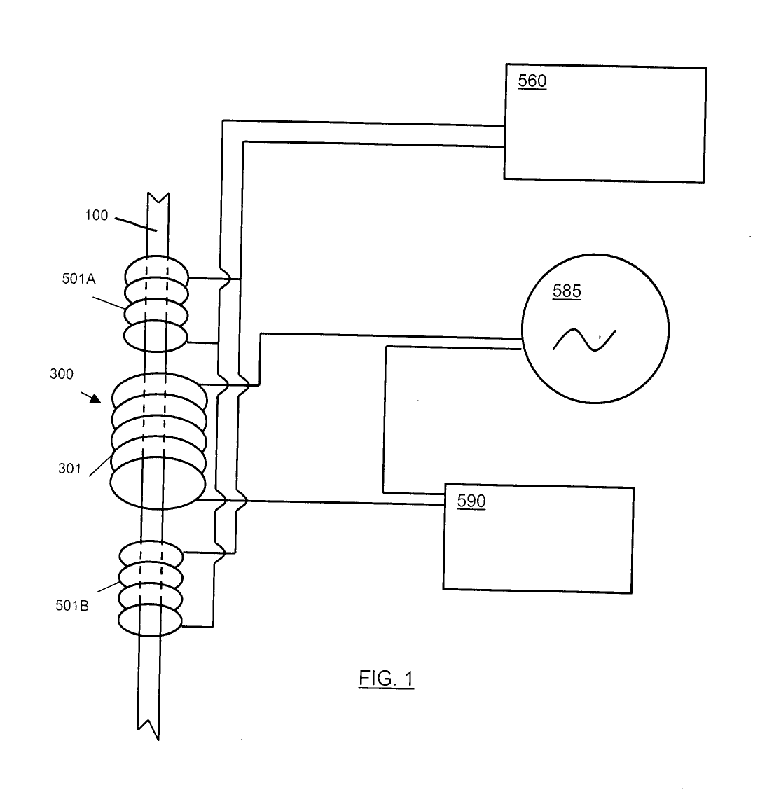

FIG. 1 schematically illustrates the components of one embodiment of the apparatus subject of the invention. It will be appreciated that the depicted apparatus includes a separate, constant or low frequency magnetic flux generating component 560 connected by conductive wires to one or more flux coils 501A and 501B that are coupled with a magnetically permeable and electrically conductive, e.g., ferromagnetic, rod 100. This constant or low frequency magnetic flux can be used to reduce the permeability of the rod 100 to facilitate a separate and oscillating or pulsed flux, illustrated to be generated by a separate oscillating or pulsed power supply 585 to couple with the rod 100 by means of a separate component 300. The voltage or effective current may be maintained constant. It is preferred that this second flux oscillates at a frequency higher than the first flux.

The second and higher frequency oscillating magnetic flux generating component 300 contains an electrically energized coil 301. This component is termed a transmitter or transmitter coil. The energized coil 301 induces an oscillating flux engaging with the ferromagnetic rod 100. By well known methods, the oscillating magnetic flux may conduct through or along the ferromagnetic rod, thereby creating an induced magnetic circuit (not shown.)

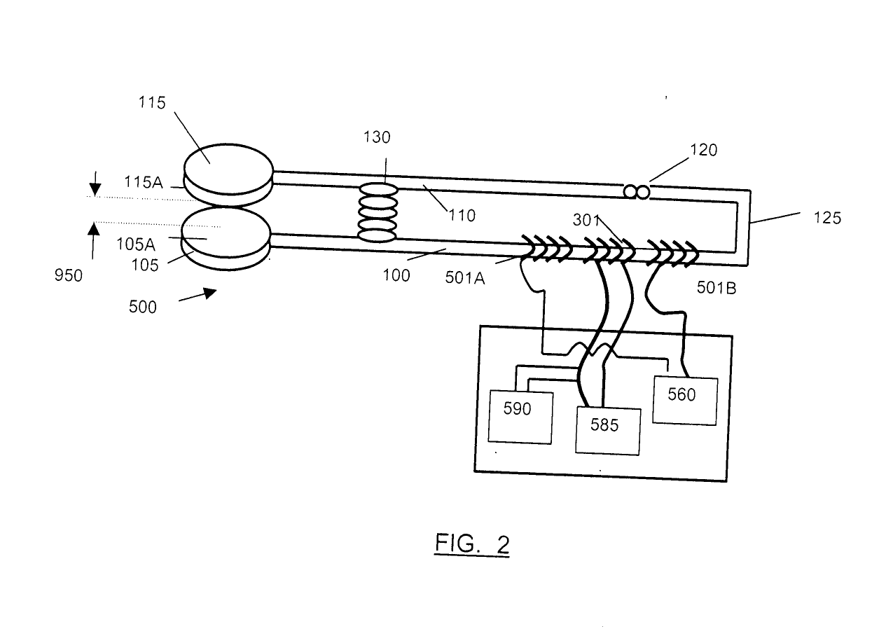

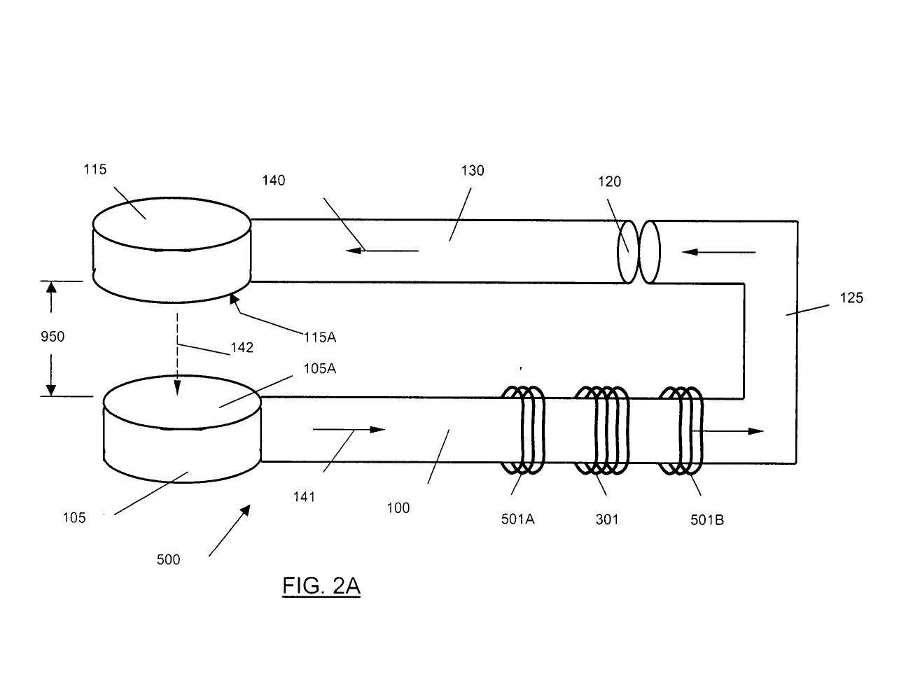

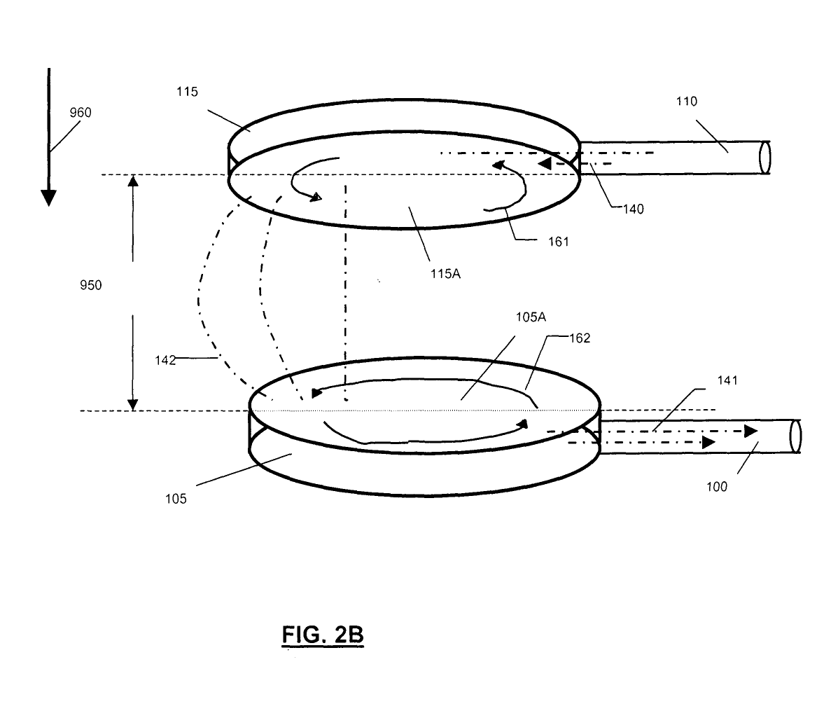

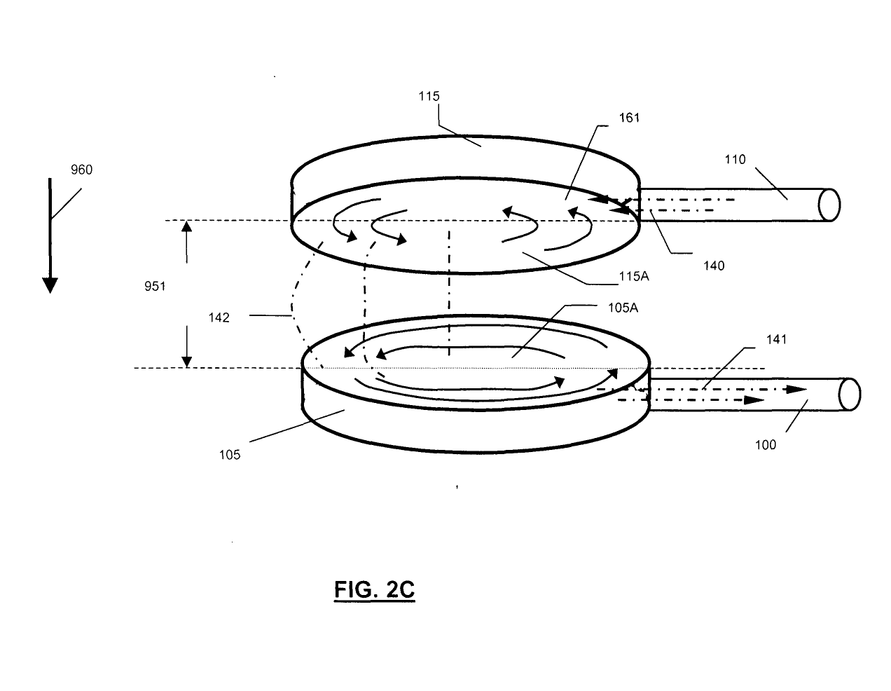

FIG. 2 illustrates an embodiment of the invention used in the recording the information discussed herein. The apparatus consists of two saturation coils 501A and 501B wound around a carbon steel (ferromagnetic) rod 100. The coils are electrically insulated from the rod. Between the two saturation coil is a single transmitter coil 301, also electrically insulated from the steel rod. At the end of the rod is an electrically conductive object, i.e., a steel disk 105 approximately 2 inches in diameter and ¼ inch thick. A second disk (i.e., an electrically conductive object) of similar size 115 is located on a substantially parallel plane 116 to the plane 106 of the first disk 105. This second disk is attached to a rod 110 that is pivotably mounted 120 to a piece 125 rigidly connected to the first rod 100. A spring 130, located between each rod 100 and 110, is used to separate the surface 105A of the first disk 105 from the opposing surface 115A of the second disk 115. It will be appreciated by persons skilled in the art that the spring is also electrically insulated from the surface of either rod and thereby does not serve as an electrical conductor. A voltage measuring device is utilized to measure changes in the voltage in response to the constant effective current.

It is, of course, well known that the lines of magnetic flux generated by the transmitter coil 301 must form a closed loop. It will be appreciated that all or a substantial portion of the oscillating flux will travel along the magnetically permeable rod 100 to a first plate or disk 105 configured to facilitate the induction of eddy currents. It will be further appreciated that the components comprising the first rod 100, the first disk 105, the space 950 between the first disk 105 and a second disk 115, a second rod 110, hinge 120, and connector rod 125 form a magnetic circuit. The magnetic flux 140 and 141 travels through or along this circuit as shown in FIG. 2A. FIG. 2A illustrates the “flow” of this magnetic circuit.

The saturation coils 501A and 501B are powered by a constant dc power source 560. The ac power cables are attached to an alternating current source 585 (oscillating at approximately 19 kHz), transmitter coil 301 and a voltage or amp meter 590.

There may be multiple transmitter coils. One or more of the transmitter coils may also serve as the component (receiver) that detects the changed signal received as a result of the variable strength eddy currents oscillating within a second plate 115 and the resulting the opposing directionality of eddy currents, i.e., bucking, within the first plate 105.

FIGS. 2B and 2C illustrates the bucking of eddy currents 161 and 162, in conjunction with the closed loop magnetic field lines comprising the magnetic circuit. The magnetic circuit includes the portion of the magnetic circuit 142 flowing across the variable sized gap or space 950 between plates 105 and 115. Proximate to the first plate, and preferably in a parallel plane, is the second similar plate or disk 115. This plate is rigidly attached to a second rod 110. This rod is pivotably attached 120 in relation to the first rod 100, thereby allowing the distance between 105 and 115 to fluctuate. A significant portion of the oscillating flux will be expected to travel across the relatively short gap 950 between 105 and 115. Change in the distance 950 between the opposing surfaces 105A and 115A will vary the induced eddy currents of each disk, resulting in a change in measured voltage or amperage.

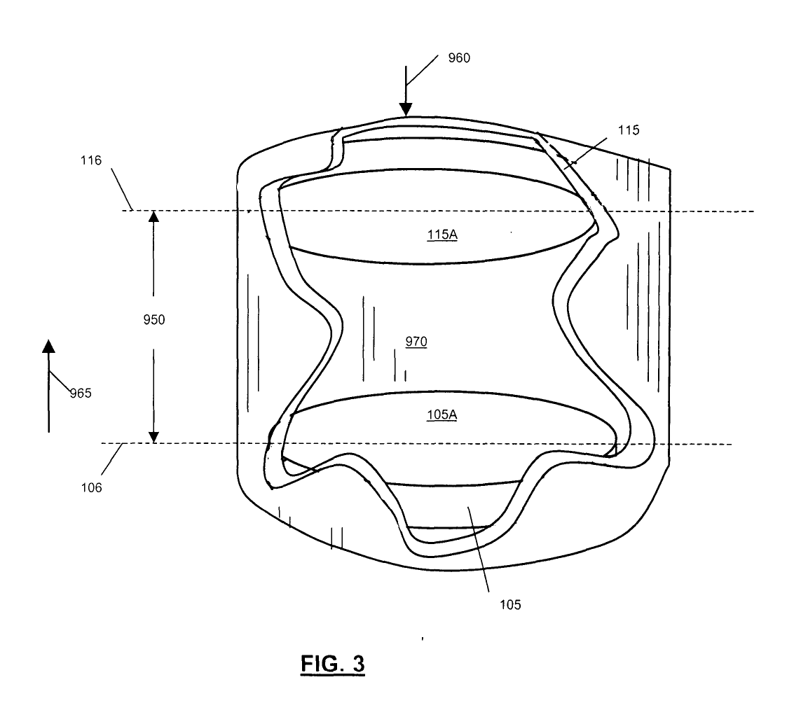

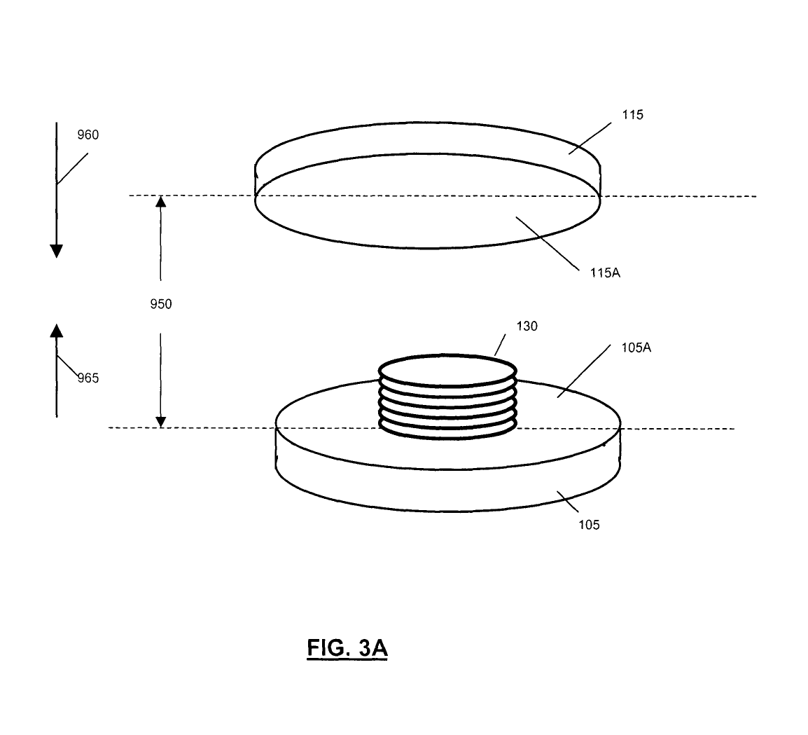

FIG. 3 illustrates the invention wherein a flexible seal 170 creates a cavity 970 that is maintained between plates 105 and 115. The cavity 970 will be decreased and the spacing 950 narrowed as a result, for example, of the increased weight of a greater liquid volume levels above the device 500. Alternatively, the space 950 could vary as a result of movement of a temperature sensitive bimetallic coil in response to temperature change. Of course, such coils are well known. Also the space could vary as a change in velocity, acceleration or impulse of the device.

In the demonstration of the invention, the effective ac current and the dc current were maintained constant at all points illustrated. The distance between the disks varied as the depth of water surrounding the disks was raised. As the distance 950 changed with the fluctuation in water height, the measured voltage reading was recorded. FIG. 3 illustrates the direction of the compressive force 960 caused by the increased volume of water in a container with fixed sides (not shown). The disks are isolated from the water by use of water-tight bellow 170. The increased depth of water caused increased compressive pressure on the disks maintained in a water tight, but flexible bellows 170 creating the cavity 970 between 105A and 115A. As the pressure increases, the distance 950 decreases between opposing surfaces 105A and 115A of 105 and 115 respectively.

FIG. 3A illustrates an alternate embodiment for maintaining an opposing force to separate the plates. It will be appreciated that although both FIGS. 2 and 3A illustrate the use of a spring to maintain a separation between the conductive plates or objects (and a countervailing force to the property of interest, e.g., temperature, pressure, volume, etc.) other mechanisms or structure may be used without departing from the invention.

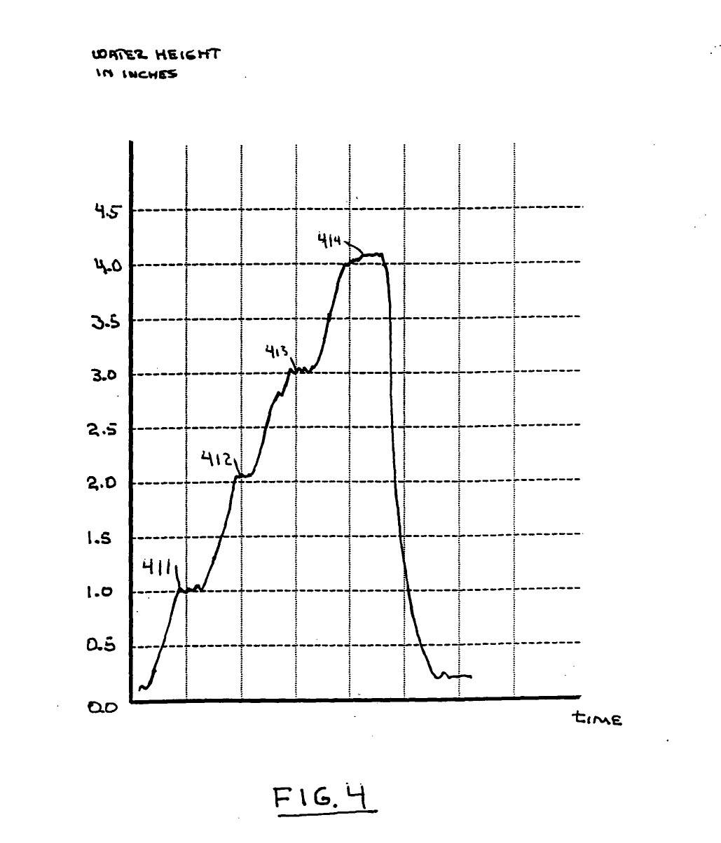

FIG. 4 illustrates the recorded change in transmitter current voltage 280 as the distance between the disks is varied. A first voltage measurement of 9.93×10⁻¹ volts 411 was recorded with the water depth surrounding the disks, 105 and 115 in FIG. 2, was at 1 inch. The depth of water was then increased to two inches and the second voltage measurement of 8.7×10⁻¹ volts 412 was recorded. Similarly the voltage measurement of 7.7×10⁻¹ 413 was recorded when the water depth was increased to 3 inches. The voltage measurement of 5.2×10⁻¹ volts 414 was recorded when the water depth was increased to 4 inches.

The data illustrated in FIG. 4 illustrates that the measured voltage decreased as the distance between the disks was reduced by the increase water pressure. This is explained by the increasing proximity of the disks (contraction of the spacing 950 in FIG. 3) causing a larger inter-action between the magnetic circuit and the induced circuit within disk 115. It will be appreciated that this interaction results in an increased dampening of the signal detectable by a decrease in voltage or current. This dampening will be detectable through a change in current or voltage within the circuit. The change can be measured by a volt or amp meter 590.

The relationship between the proximity or movement of the disks 105 and 115 and measured voltage or current has been consistently and repeatably shown. The recorded voltage (when the circuit utilizes a constant current) or amperage (when the circuit utilizes a constant voltage) can be reliably used to indicate the amount of separation between the two points. Further, the readings are created solely from the magnetic component of electromagnetic energy thereby reducing or minimizing error resulting from mechanical factors.

It will be appreciated by persons skilled in the art that the apparatus can be configured to reflect changes in various environments, e.g., pressure, temperature, or properties, e.g. velocity, acceleration, vibration.

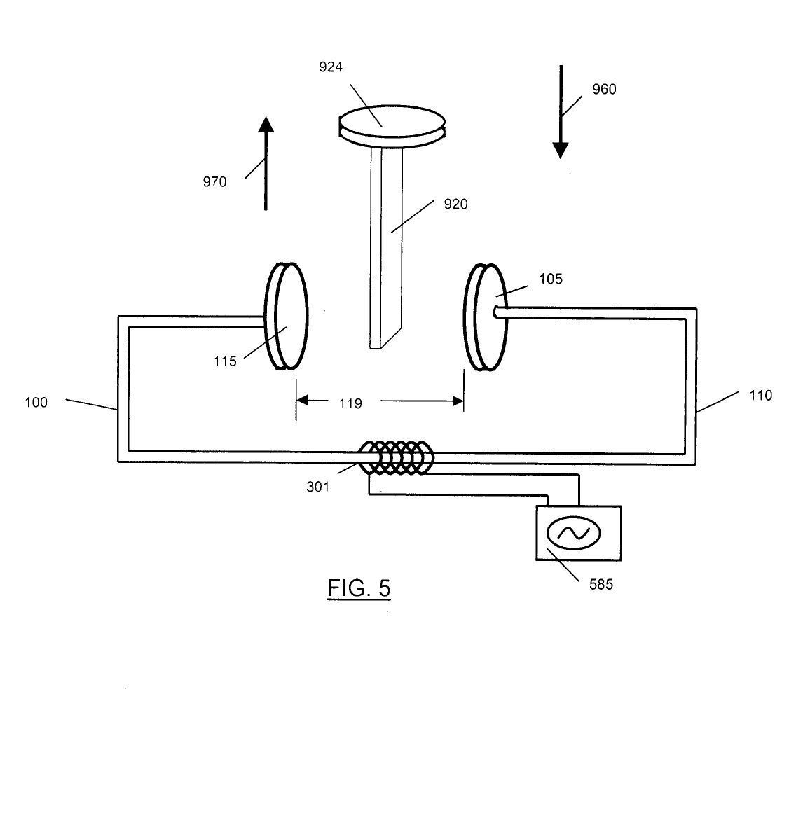

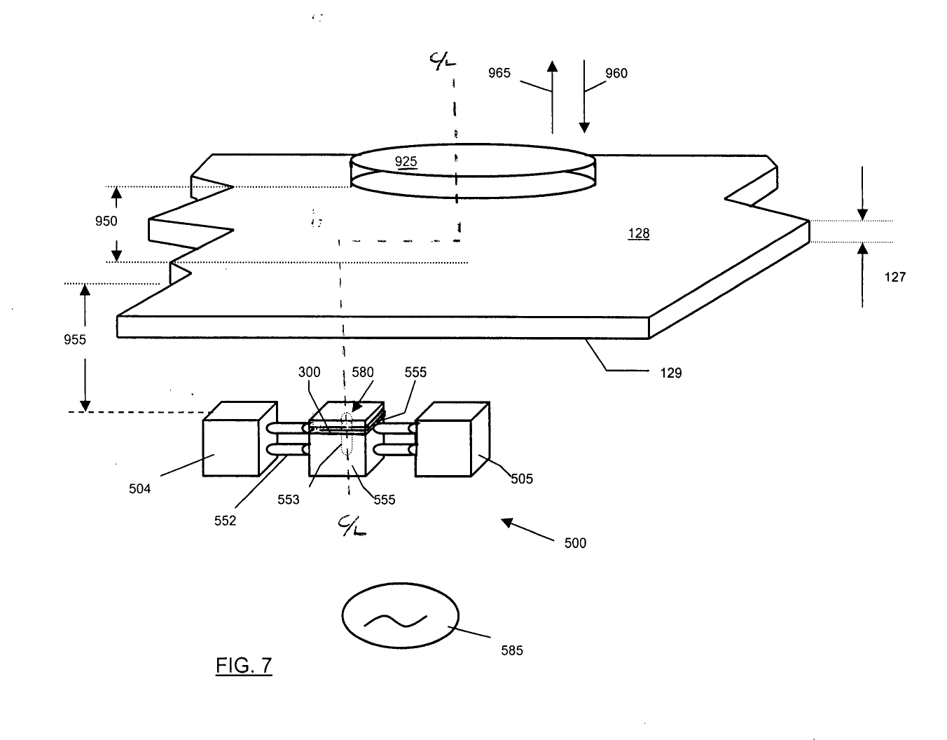

Persons skilled in the art will also appreciate that the second disk 115 illustrated in FIG. 2 need not be part of the magnetic circuit. FIGS. 5 and 7 illustrate embodiments of the invention wherein the components 920/924 and 925 respectively comprise separate moveable components. Considering FIG. 5 first, the component 920/924 alter the measured voltage induced within the magnetic circuit comprised of 100, 115, 105, and 110. The component 920/924 may be maintained outside of the magnetic flux crossing (not shown) between 115 and 105 through the space 119. The “tongue” 920 can be moved into space 119 in response to pressure or other force in the direction 960 or retracted by a spring force (not shown) or similar means in direction 970. It will be readily appreciated that the movement of the tongue component 920, comprised of an electrically conductive material, through or into the space 119 containing an oscillating magnetic flux, result in eddy currents being induced within the tongue. These eddy currents can be used to modify the voltage of the oscillating current induced by the transmitter coils 301 from the generator 585.

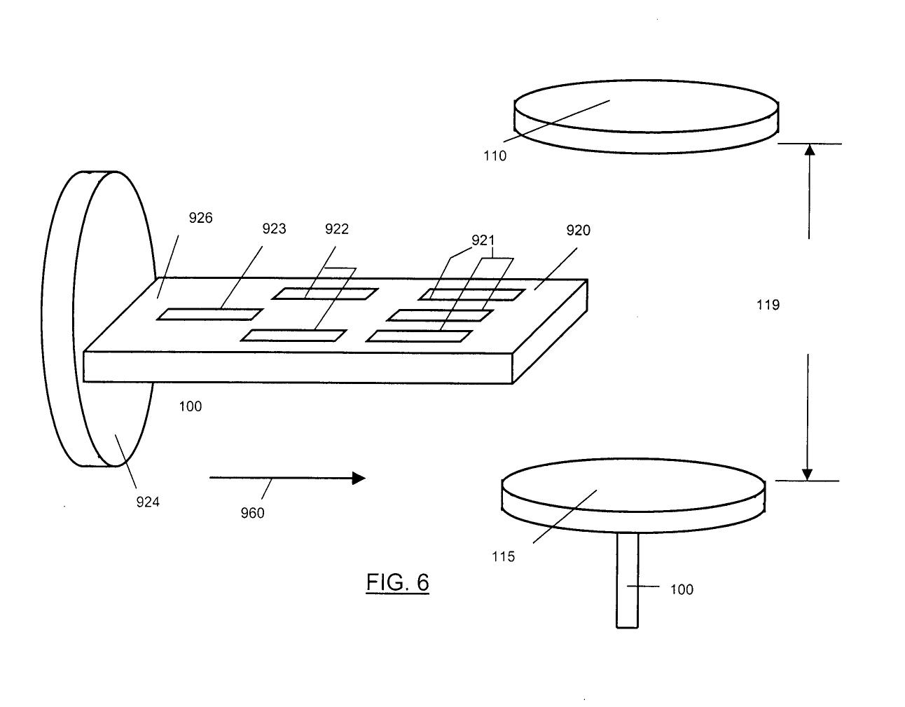

FIG. 6 illustrates an embodiment of the invention utilizing the tongue component 920 attached to a top plate 924. The structure of the tongue contains varying spaced barriers 921, 922, and 923 to eddy currents. It will be appreciated that the upper portion 926 of the tongue does not contain such eddy current barriers. Accordingly, as the tongue 920 is inserted further 960 into the space 119 between the plates 105 and 115, there will be less impedance to the induction of eddy currents within the tongue that will alter the voltage induced by the magnetic circuit.

FIG. 7 illustrates yet another embodiment of the invention. The magnetic flux generator 500 is separated from the moveable and electrically conductive plate 925 by a wall 128. It will be appreciated that the wall may be comprised of magnetically permeable and electrically conductive material, e.g., a steel tank or pipe wall. In the illustrated embodiment, an electrically conductive disk 925 (obviously an electrically conductive object) is utilized in conjunction with the flux generator 500. The flux generator is comprised of a transmitter coil 300, alternating power supply 585 connected to the transmitter coil by means not shown, amp meter (not shown), four (4) saturation flux generating coils 552 wrapped around saturation cores (not shown), a magnetic culminator 555 and two poles 504 and 505 of like polarity (and having polarity opposite that of the culminator 555). It will be appreciated that the culminator, saturation flux cores and poles are comprised of highly magnetically permeable material. The saturation flux generator is located proximate to the side 129 of the wall opposite the remote electrically conductive disk 925. In a preferred embodiment both the disk 925 and culminator 555 have substantially the same center axis C/L. Accordingly, the space 955 may be minimal or non-existent.

The saturation flux generator can be powered by a dc power source or low frequency ac power source (not shown). The magnetic flux emitted from culminator 555, and magnetic poles 504 and 505 are used to create a Metallic Transparency™ within a portion of the wall 128. The transparency will permeate through the thickness 127 of the wall 128. In conjunction with the creation of this transparency, the transmitter coil is energized with ac power (or pulsed dc power) that will create an oscillating or variable magnetic flux to be emitted from the side of the culminator 555 adjacent to the side 129 of the wall 128. A portion of the oscillating magnetic flux (not shown) will couple with and permeate through the thickness 127 of the steel tank wall proximate to the area of the Metallic Transparency. The remote and electrically conductive component disk 925 may intersect some of the field lines generated by the transmitter coil. The number of field lines intersected by component disk 925 will increased when the disk moves toward the wall 128 in direction 960 due to increased pressure or other mechanical force. (It will also be appreciated that the remote component disk 925 may also move in the opposite direction 965 as a result of another force, such as buoyancy (as a float) or spring pressure, or in response to a lessening of pressure or other mechanical force.) Examples of forces causing movement of remote component 925 in direction 960 or 965 may also include varying factors such as change in the internal tank pressure, liquid level in the tank, change in temperature, movement of the tank or tank contents, etc. In a preferred embodiment, the distance 955 between the magnetic flux generator 500 and the first surface 129 of the wall 128 is fixed or constant. The proximity of the remote disk 925 to the wall 128, and hence the transmitter 300, will influence the quantity of flux density or number or magnetic field lines intersected by the remote disk. As this quantity changes, the interaction with the magnetic field can be detected and measured by change in voltage or amperage of electrical current energizing the transmitter coil 300.

In an alternate method, the interaction can be detected by a separate receiver coil 580. In a preferred embodiment, the receiver is located in an annulus 553 located within the culminator 555 and approximately axially centered with respect to the transmitter coil 300.

Of course, a constant magnetic force, supplied by a permanent magnet or dc power source may be sufficient for the operation of the invention. The movement of the electrically conductive disk (object) 115, depicted in FIG. 2, or component plate 925, shown in FIG. 7, within a constant magnetic field will generate an electric current that may be detected.

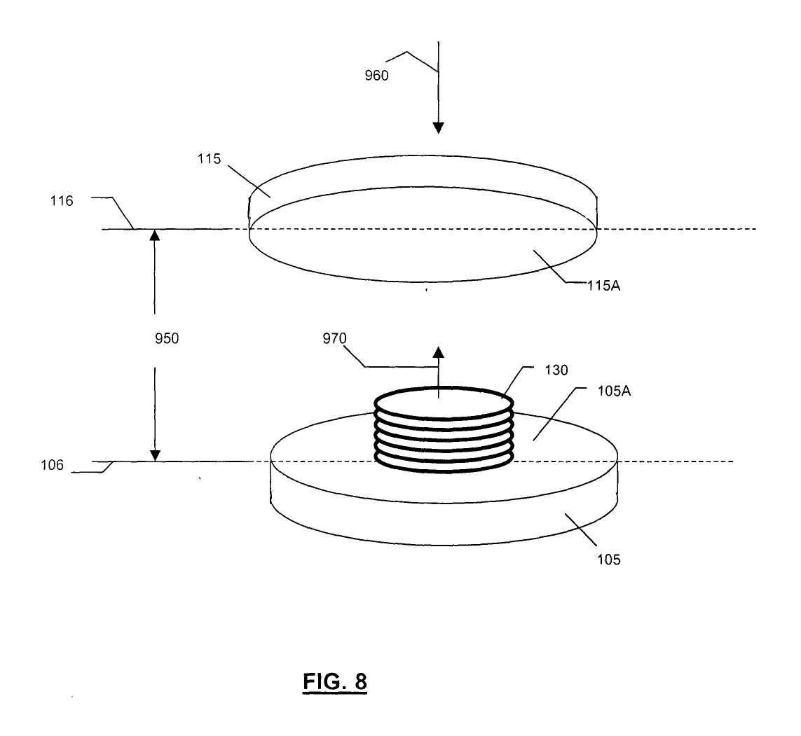

FIG. 8 illustrates another embodiment for creating a space 950 between the opposing surfaces 105A and 115A of the disks 105 and 115. A spring 130 is placed between the disks.

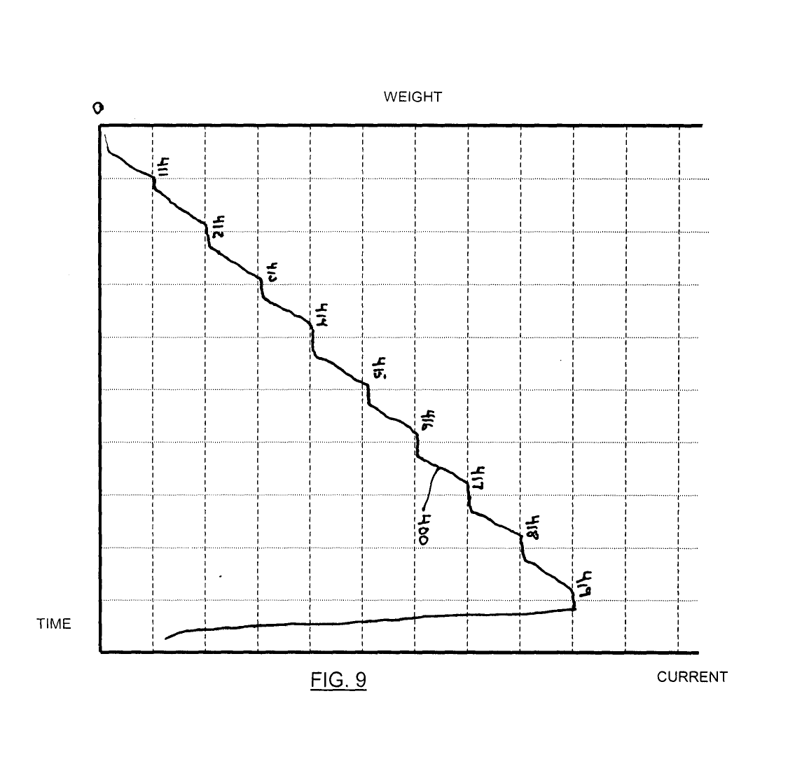

FIG. 9 illustrates the recorded changes of current as the pressure (in ounces) was increased on the surface of 925, causing the electrically conductive disk (object) 925 to move toward the surface of a carbon steel pipe wall in the direction 965. The recorded data was processed by standard or known polynomial expressions and curve fitting techniques. The resulting data shows a clear ability to monitor or measure the force of the pressure by means of the recorded change in current. For example, the change in position along curve 400 between 412 and 415 is the result of an increase of 4 ounces per unit area of pressure.

This specification is to be construed as illustrative only and is for the purpose of teaching those skilled in the art the manner of carrying out the invention. It is to be understood that the forms of the invention herein shown and describe are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention may be utilized independently of the use of other features, all as would be apparent to one skilled in the art after having the benefit of this description of the invention.

Further modifications and alternative embodiments of this invention will be apparent to those skilled in the art in view of this specification.

What is claimed is:

1. A method for detecting change by interaction of electromagnetic energy comprising the steps of:
a. generating a first electric current;
b. inducing a first magnetic field from the electric current;
c. placing a moveable and electrically conductive object proximate to the first magnetic field but insulated from the first electric current;
d. maintaining the direction of movement of the object such that movement causes a change in the number of field lines of the first magnetic field intersected by the object; and
e. detecting a change in one characteristic of the first electrical current from a group comprising, impedance, voltage, and amperage, in response to the object moving in relation to the first magnetic field.

2. A method for detecting change by interaction of electromagnetic energy comprising the steps of:
a. generating a first electric current;
b. inducing a first magnetic field from the electric current;
c. engaging the first magnetic field with a magnetic circuit containing a gap within the circuit and with a first circuit end and second circuit end and a moveable circuit component that can change the size of the circuit gap;
d. inducing eddy currents within the first circuit end and the second circuit gap end;
e. detecting a change in one characteristic of the first electrical current from a group comprising, impedance, voltage, and amperage, in response to a change in the size of the circuit gap due to movement of the moveable circuit component.

3. The method of claim 1 or 2 further comprising limiting the movement of the electrical conductive object in response to a change in an environment.

4. The method of claim 3 further comprising the change to be one of a group comprising pressure, temperature, volume, velocity, acceleration and impulse.

5. An apparatus for detecting change by interaction of electromagnetic energy comprising:
a. an electric current source for providing a first electric current and a first magnetic field;
b. a moveable and electrically conductive object proximate to but insulated from the first electric current;
c. a mechanism for maintaining the direction of movement of the object such that movement causes a change in the number of field lines of the first magnetic field intersected by the object; and
d. a mechanism for detecting change in at least one of a group of electrical properties of the first electric current, comprised of impedance, voltage or current, in response to movement of the electrically conductive object.

6. An apparatus for detecting change by interaction of electromagnetic energy comprising:
a. an dc electric current source, proximate to a first side of an electrically conductive or magnetically permeable material surface having a first and second side, for providing a first dc electric current and first magnetic field lines penetrating through the first side and second side of the material;
b. an electrically conductive object located proximate to the surface of the second side of the material and substantially opposite to the dc current source;
c. a mechanism for maintaining the direction of movement of the object such that movement causes the number of field lines intersected by the object to change; and
d. a mechanism for detecting a change in the electric current resulting from the change in magnetic field lines intersected by the object.

7. An apparatus for detecting change by interaction of electromagnetic energy, comprising:
a. a dc electric current source for providing a first dc electric current and a first magnetic field;
b. an ac electric current source for providing a second ac electric current and an oscillating magnetic field;
c. a magnetic circuit comprising magnetically permeable material with at least one component that is moveable in relation to the other components of the circuit and whereas the movement of the component changes the size of a gap within the circuit;
d. at least one transmitter of the first magnetic field proximate to a first portion of the circuit to engage the circuit and lower the permeability of the first portion of the circuit;
e. at least one transmitter of the oscillating magnetic flux proximate to the first portion of the circuit to engage the magnetic circuit with the oscillating flux sufficient for a portion of the oscillating magnetic field lines to be conducted along the magnetic circuit;
f. a mechanism for causing the direction of movement to change the number of magnetic field lines intersected by the moveable component; and
g. a mechanism for measuring the change in the second ac current.

8. The apparatus of claims 5, 6 or 7 wherein the movement is controlled by a change of a property from a group of properties consisting of pressure, temperature, volume, velocity, acceleration and impulse.

9. The apparatus for detecting change in properties, including but not limited to change in volume, pressure, temperature, velocity, acceleration, or impulse, comprising:
a. an dc electric current source proximate to a first side of an electrically conductive or magnetically permeable material surface having a first and second side for providing a first dc electric current and a first magnetic field;
b. an ac electric current source proximate to the first side of the material and the dc electric current source for providing a second electric current and an oscillating magnetic field lines penetrating through the first side and second sides of the material;
c. an electrically conductive object located proximate to the surface of the second side of the material and substantially opposite the dc and ac current sources proximate to the first side;
d. a mechanism for allowing the object to move in response to changes in properties such that the movement changes the number of intersected oscillating magnetic field lines; and
e. a mechanism for detecting a change in the electric current resulting from the change in magnetic field lines intersected by the object.
